(19) United States
(12) Patent Application Publication
(10) Pub. No.: US 2024/0315282 A1
(43) Pub. Date: Sep. 26, 2024

(54) Composite Nutritional Freeze-Dried Snack Containing Bacteriophage And Preparation Method And Use Thereof

(71) Applicant: MASONBIO INC., Mason, OH (US)

(72) Inventors: Xudong Mao, Mason, OH (US); John Pan, Mason, OH (US); Helen Cao, Mason, OH (US); Andrew Lin, Mason, OH (US); Hans J. Vogel, Mason, OH (US)

(21) Appl. No.: 18/735,070

(22) Filed: Jun. 5, 2024

(51) Int. Cl. A23K 20/00; A23K 10/20; A23K 10/30; A23K 40/00; A23K 50/42

(52) U.S. Cl. CPC A23K 20/00; A23K 10/20; A23K 10/30; A23K 40/00; A23K 50/42

(57) ABSTRACT

The present disclosure relates to the field of pet foods, and provides a composite nutritional freeze-dried snack containing a bacteriophage and a preparation method and a use thereof. The composite nutritional freeze-dried snack includes a nutritional mixture and an egg. A nutrition proportion provided by each plant extract in the composite nutritional freeze-dried snack provided by the present disclosure can achieve the effects of promoting growth of dogs and cats, resisting oxidation, strengthening immunity, resisting respiratory system infection, preventing pets from infection with pathogens and the like. Therefore, the composite nutritional freeze-dried snack has a good market prospect.

### TECHNICAL FIELD

The present disclosure relates to the technical field of pet foods, and in particular to a composite nutritional freeze-dried snack containing a bacteriophage and a preparation method and a use thereof.

### BACKGROUND

A nutritional value and a storage condition of pet foods in the market can be realized by various different processes (such as puffing, low-temperature baking, lyophilization, high-temperature cooking, and high-pressure filling), so as to facilitate commodity circulation. However, some vitamins and mineral substances are required to be additionally added by chemical substances, and gradually lost or oxidized along with the delay of their shelf lives. Therefore, certain risks exist in the aspects of safety, timeliness and the like. A food formula capable of improving pet health and preventing a pet from infection with pathogens is still needed in the market.

### SUMMARY

The present disclosure aims to solve the technical problems that an existing food nutritional supplement for a pet has a poor effect on promoting growth of the pet, and cannot prevent the pet from infection with pathogens and the like. Aiming at the defects in the prior art, the present disclosure provides a composite nutritional freeze-dried snack containing a bacteriophage and a preparation method and a use thereof.

In order to solve the above technical problems, the present disclosure provides a composite nutritional freeze-dried snack. The composite nutritional freeze-dried snack includes a nutritional mixture and an egg, where a mass ratio of the egg to the nutritional mixture is (8-10): 1. The nutritional mixture includes the following components in parts by weight: 10-20 parts of a haw extract, 5-10 parts of a Rhizoma alismatis extract, 10-20 parts of a grape seed extract, 5-10 parts of a Radix valerianae extract, 10-20 parts of brown seaweed polysaccharides, 10-20 parts of a red kojic rice extract, 20-30 parts of taurine, 10-20 parts of water-soluble pearl powder, 5-10 parts of dragon fruit powder, and 1-5 parts of a bacteriophage.

The haw extract, the Rhizoma alismatis extract, the grape seed extract, the Radix valerianae extract, the red kojic rice extract, the water-soluble pearl powder, and other substances can all be commercially available.

The bacteriophage is selected from Escherichia coli bacteriophage, Salmonella bacteriophage, Clostridium welchii bacteriophage and Staphylococcus bacteriophage.

In the present disclosure, an egg yolk contains rich lecithin which is derived from an animal embryo. The lecithin itself is a powerful emulsifier, can reduce sizes of cholesterol and fat particles to keep them in a suspended state, has proper content, proportion and structure with amino acids, ω-3 fatty acid, ω-6 fatty acid, cholesterol and the like, and can permeate through a blood vessel wall to be directly absorbed and utilized by cells. Lecithin molecules have two ends, wherein one hydrophilic end can be absorbed by water, and the other hydrophobic end will be repelled by water but can be fused with oil. Therefore, the lecithin in the egg yolk as an emulsifier can stabilize oil in plants. After the plant extracts are mixed, the end capable of being absorbed by the water is dissolved into the water, and fused with the egg; the end repelled by the water is attracted by oil particles, and tightly surrounds and seals them, such that nutrient molecules remain intact, and are evenly distributed in the egg.

In the present disclosure, through the composition and reasonable proportion of the raw materials, the nutritional effect of the composite nutritional freeze-dried snack can be ensured to fully promote the growth of the pet. Besides, the composite nutritional freeze-dried snack has an antioxidation effect, and can strengthen immunity, resist respiratory system infection, and effectively prevent or treat diseases caused by Escherichia coli, Salmonella and the like.

The preferred mass ratio of the egg to the nutritional mixture, palatability and nutritional effect of the present disclosure are most suitable for dogs and cats. No adverse reaction is caused. Excessive plant extracts can affect the palatability, and also easily cause intestinal discomfort, diarrhea and other symptoms due to over nutrition. Too few plant extracts (the nutritional mixture) may affect the effect.

Preferably, the egg is a chicken egg.

The egg of the present disclosure includes, but is not limited to, the listed egg without special limitation. As long as it has an emulsifying effect, the egg providing the lecithin is suitable for the present disclosure.

The chicken egg is preferably used as a carrier. On one hand, a special smell of the plant extracts can be covered, and the palatability of the product to pet is improved; and on the other hand, the pet can also absorb nutrients in the chicken egg. The chicken egg contains almost all the required vitamins and minerals (except fibers and vitamin C), and is the most digestible protein source with the highest biological value. The chicken egg provides complete essential amino acids, and is rich in DHA, various vitamins (such as VA/VE) and iron, which are mainly concentrated in the egg yolk. The lecithin in the egg yolk has an emulsifying effect, such that the plant extracts can be directly absorbed through the vessel wall.

Preferably, the nutritional mixture includes the following components in parts by weight: 15 parts of the haw extract, 8 parts of the Rhizoma alismatis extract, 15 parts of the grape seed extract, 7 parts of the Radix valerianae extract, 15 parts of the brown seaweed polysaccharides, 15 parts of the red kojic rice extract, 25 parts of the taurine, 15 parts of the water-soluble pearl powder, 5 parts of the dragon fruit powder, and 3 parts of the bacteriophage.

In the present disclosure, the nutritional mixture in the above proportion has a better effect when being used in the composite nutritional freeze-dried snack.

The present disclosure further provides a preparation method for a composite nutritional freeze-dried snack, including the following steps:
(1) mixing a haw extract, a Rhizoma alismatis extract, a grape seed extract, a Radix valerianae extract, brown seaweed polysaccharides, a red kojic rice extract, and a bacteriophage to obtain a first mixture; and mixing water-soluble pearl powder, taurine and dragon fruit powder in water to obtain a second mixture; and
(2) mixing a chicken egg with the first mixture and the second mixture, pouring a mixture into a mold, standing the mixture to empty air, and then lyophilizing the mixture to obtain the composite nutritional freeze-dried snack,
During preparation of the present disclosure, the water-soluble pearl powder, the taurine, and the dragon fruit powder are required to be first dissolved and mixed together, and then mixed with other substances, such that all the substances can be evenly mixed together. Since the taurine, the pearl powder, and the dragon fruit powder are all water-soluble, they need to be firstly completely dissolved before being better evenly absorbed. After the lecithin in the egg yolk is dissolved into the water, it can be combined with the hydrophilic end, and thus the emulsifying function can be played. If all the components in the nutritional mixture are mixed together directly, the effect becomes poor.

Preferably, the lyophilizing is performed under vacuum.

Preferably, the lyophilizing is performed for more than 20 h.

In the present disclosure, the lyophilizing is freeze-drying. The lyophilizing sublimates water, does not damage the nutrients in the raw materials, and can ensure the shelf life of a product. The lyophilizing has various advantages, specifically including: the lyophilizing is performed at a low temperature, and thus particularly suitable for many heat-sensitive substances, such as active proteins, polypeptides and microbial agents. When the substances are dried at the low temperature, some volatile components in the substances are slightly lost, such that the lyophilizing is suitable for drying some chemical products, medicines and foods. During the lyophilizing, growth of microorganisms and the action of enzymes can be inhibited, such that the product can maintain original properties. The drying can remove more than 95-99% of the water, and the dried product can be stored for a long time without deterioration. Since the drying is performed in a frozen state, a volume is almost unchanged, an original structure is kept, and a concentration phenomenon cannot occur. Since the drying is performed under vacuum, some substances which are easy to oxidize are protected. The dried substances are loose, porous and spongy, and can be dissolved quickly and completely after addition of the water, and the original properties can be recovered almost immediately.

Preferably, the standing is performed for 0.8-2 h, preferably 1 h.

In the present disclosure, the standing is a key step in the preparation process. The air can be naturally emptied by mixing and standing, such that the nutrients in various components are prevented from being oxidized.

In a third aspect, the present disclosure provides a use of the composite nutritional freeze-dried snack according to the first aspect in the preparation of a food nutritional supplement for a pet.

The composite nutritional freeze-dried snack provided by the present disclosure can be further used as the food nutritional supplement for the pet, and the pet may be commonly domestic, such as a cat and a dog.

Preferably, the pet is the cat.

The composite nutritional freeze-dried snack provided by the present disclosure is most suitable for feeding the cat. Generally, when a young cat in a weaning period takes the food nutritional supplement for the pet, it can take 1 g of the composite nutritional freeze-dried snack on the basis of its normal body weight. An adult cat weighing 5 kg generally takes 2 g of the composite nutritional freeze-dried snack as the food nutritional supplement.

The present disclosure is most suitable for the cat. It is because the cat is smaller in size than the dog, and most cats have the body weights within 5 kg which may be used as a unit feeding capacity, and an increase in feed capacity is deduced by analogy. Besides, the dog belongs to carnivorousness-prone omnivorous animals, while the cat is a carnivorous animal, commonly has a respiratory tract problem, and is relatively repulsive to the plant extracts. The nutritional freeze-dried snack itself can make the cat love eating the nutritional freeze-dried snack by its own and thus ingest corresponding nutrients which are beneficial to body.

The composite nutritional freeze-dried snack provided by the present disclosure is developed from the physiological angle of the dog and the cat, and aiming at a special physiological structure of the dog or the cat. By wrapping of the bacteriophage with the egg and the nutritional proportion of the various plant extracts, on the basis of ensurance of a delicate flavor, enhancement in the palatability and quick absorption, various vitamins, minerals and trace elements are proportioned from various plant extracts; and the egg is used for wrapping to isolate air, and the lecithin in the egg has the emulsifying effect, such that various nutrients can smoothly enter cells through the vascular wall to be absorbed, and the pet can be supplemented with natural nutrients. The composite nutritional freeze-dried snack promotes the growth of the dog or the cat, resists oxidation, enhances immunity, resists respiratory system infection, and can prevent or treat infectious diseases (such as gastroenteritis, diarrhea, an urologic disease or the like) caused by pathogenic bacteria in bacterial families such as Escherichia coli, Salmonella, Clostridium welchii or Staphylococcus in the pet. In addition, the composite nutritional freeze-dried snack of the present disclosure can keep activity for a long time, can prevent and control growth of pathogens and spoilage organisms in the foods and an environment, and has a great application prospect.

### DETAILED DESCRIPTION

In order to make the objectives, the technical solutions and the advantages of the examples of the present disclosure clearer, the following clearly and completely describes the technical solutions in the examples of the present disclosure with reference to accompanying drawings in the examples of the present disclosure. Apparently, the described examples are some rather than all of the examples of the present disclosure. All other examples obtained by a person of ordinary skill in the art on the basis of the examples of the present disclosure without creative efforts shall fall within the protection scope of the present disclosure.

### Example 1

The present disclosure provided a composite nutritional freeze-dried snack: a nutritional mixture and 877 parts of a chicken egg. The nutritional mixture included 15 parts of a haw extract, 8 parts of a Rhizoma alismatis extract, 15 parts of a grape seed extract, 7 parts of a Radix valerianae extract, 15 parts of brown seaweed polysaccharides, 15 parts of a red kojic rice extract, 25 parts of taurine, 15 parts of water-soluble pearl powder, 5 parts of dragon fruit powder, and 3 parts of a Salmonella bacteriophage.

A specific preparation process was as follows:
(1) the haw extract, the Rhizoma alismatis extract, the grape seed extract, the Radix valerianae extract, the brown seaweed polysaccharides, the red kojic rice extract, and the Salmonella bacteriophage were mixed to obtain a first mixture; and the water-soluble pearl powder, the taurine, and the dragon fruit powder were mixed in water to obtain a second mixture; and
(2) the chicken egg was mixed with the first mixture and the second mixture; after being fully emulsified and fused, a mixture was poured into a mold and stood for 1 h to empty air; and then the mixture was lyophilized for 25 h to obtain the composite nutritional freeze-dried snack.

The composite nutritional freeze-dried snack provided in example 1 was actually tested as a food supplement. Original foods (as a control group) and the foods added with the nutritional freeze-dried snack with an addition amount of 2 g/5 kg (the nutritional freeze-dried snack provided by example 1 as an experimental group) were respectively used for feeding for four weeks, absorption conditions of the body before and after the addition were compared. A recording standard was comparing absorption of different nutrients in five different parts of the body. The five parts of the body, namely eyelids, gum and oral tissues, a skin condition, a hair condition and an energy level were used to observe body absorption of various nutrients from the foods. Results showed that in comparison of an eight-week feeding test of 12 pet cats, after the nutritional freeze-dried snack was added, average absorptivity of the foods was increased from 25% to 40%; a recurrence frequency of the respiratory tract problems was reduced from 3 times to 1 time; a frequency of diarrhea was reduced from 14 times to 2 times; and the body weight was increased by 8% on average.

The composite nutritional freeze-dried snack provided in example 1 was actually tested as a food supplement. Original foods (as a control group) and the foods added with the nutritional freeze-dried snack with an addition amount of 5 g/5 kg (the nutritional freeze-dried snack provided by example 1 as an experimental group) were respectively used for feeding for four weeks, absorption conditions of the body before and after the addition were compared. A recording standard was comparing absorption of different nutrients in five different parts of the body. The five parts of the body, namely the eyelids, the gum and oral tissues, the skin condition, the hair condition and the energy level were used to observe body absorption of various nutrients from the foods. Results showed that in comparison of an eight-week feeding test of 12 pet dogs, after the nutritional freeze-dried snack was added, average absorptivity of the foods was increased from 20% to 42%; a recurrence frequency of the respiratory tract problems was reduced from 4 times to 1 time; a frequency of diarrhea was reduced from 12 times to 1 time; and the body weight was increased by 12% on average.

From a nutrient absorption data table, nutrient absorption of each part of the body to the foods was good, and proteins, amino acids, vitamins, minerals, and trace elements all had a good assimilation effect in the body. The composite nutritional freeze-dried snack had an obvious improvement effect on the pets with respiratory tract problems, had a synergistic antioxidation effect, enhanced immunity of the pets, obviously increased the body absorptivity and the body weights, and reduced the occurrence frequencies of diseases.

From the overall feeding test, the composite nutritional freeze-dried snack could effectively promote growth of the pets, resist oxidation, strengthen immunity, and resist respiratory tract infection, and could prevent or treat infectious diseases (such as gastroenteritis, diarrhea, and an urologic disease) caused by pathogenic Enterobacteriaceae such as Salmonella in the pets.

### Example 2

Example 2 was basically the same as example 1, except that the Salmonella bacteriophage was replaced with an Escherichia coli bacteriophage, a Clostridium welchii bacteriophage or a Staphylococcus bacteriophage.

From the nutrient absorption data table, nutrient absorption of each part of the body of each pet cat/dog to the foods was good, and the proteins, the amino acids, the vitamins, the minerals, and the trace elements all had good assimilation effect in the body. The composite nutritional freeze-dried snack had an obvious improvement effect on the pets with the respiratory tract problems, had a synergistic antioxidation effect, enhanced the immunity of the pets, obviously increased the body absorptivity and the body weight, and reduced the occurrence frequencies of the diseases.

From the overall feeding test, the composite nutritional freeze-dried snack could effectively promote the growth of the pets, resist oxidation, strengthen the immunity, and resist respiratory tract infection, and could prevent or treat the infectious diseases (such as the gastroenteritis, the diarrhea, and the urologic diseases) caused by the pathogenic bacteria such as the Escherichia coli, the Clostridium welchii or the Staphylococcus.

Finally, it should be noted that the foregoing examples only used to illustrate the technical solutions of the present disclosure, and are not intended to limit the same. Although the present disclosure is described in detail with reference to the foregoing examples, a person of ordinary skill in the art should understand that they can still modify the technical solutions described in the foregoing examples, or make equivalent substitutions to some technical features therein. These modifications or substitutions do not make the essence of the corresponding technical solutions depart from the spirit and scope of the technical solutions of various examples of the present disclosure.

1. A composite nutritional freeze-dried snack containing a bacteriophage, comprising a nutritional mixture and an egg, wherein a mass ratio of the egg to the nutritional mixture is (8-10): 1, and the nutritional mixture comprises the following components in parts by weight: 10-20 parts of a haw extract, 5-10 parts of a Rhizoma alismatis extract, 10-20 parts of a grape seed extract, 5-10 parts of a Radix valerianae extract, 10-20 parts of brown seaweed polysaccharides, 10-20 parts of a red kojic rice extract, 20-30 parts of taurine, 10-20 parts of water-soluble pearl powder, 5-10 parts of dragon fruit powder, and 1-5 parts of a bacteriophage; the bacteriophage is selected from Escherichia coli bacteriophage, Salmonella bacteriophage, Clostridium welchii bacteriophage and Staphylococcus bacteriophage; the egg is a chicken egg; and the nutritional mixture comprises the following components in parts by weight: 15 parts of the haw extract, 8 parts of the Rhizoma alismatis extract, 15 parts of the grape seed extract, 7 parts of the Radix valerianae extract, 15 parts of the brown seaweed polysaccharides, 15 parts of the red kojic rice extract, 25 parts of the taurine, 15 parts of the water-soluble pearl powder, 5 parts of the dragon fruit powder, and 3 parts of the bacteriophage.

2. A preparation method for the composite nutritional freeze-dried snack according to claim 1, wherein the preparation method comprises the following steps:
(1) mixing a haw extract, a Rhizoma alismatis extract, a grape seed extract, a Radix valerianae extract, brown seaweed polysaccharides, a red kojic rice extract, and a bacteriophage to obtain a first mixture; and mixing water-soluble pearl powder, taurine, and dragon fruit powder in water to obtain a second mixture; and
(2) mixing the chicken egg with the first mixture and the second mixture, pouring the mixture into a mold, standing the mixture to empty air, and then lyophilizing the mixture to obtain the composite nutritional freeze-dried snack,
wherein the lyophilizing is performed under vacuum; and
the lyophilizing is performed for more than 20 h.

3. The preparation method according to claim 2, the standing is performed for 0.8-2 h, preferably 1 h.

4. A use of the composite nutritional freeze-dried snack according to claim 1 in the preparation of a food nutritional supplement for a pet.

5. The use according to claim 4, wherein the pet is a cat or a dog.
